(19) United States
(12) Patent Application Publication
(10) Pub. No.: US 2022/0389184 A1
(43) Pub. Date: Dec. 8, 2022

(54) INKS AND LABELS TO FACILITATE RECYCLING

(71) Applicant: SWIMC LLC, Cleveland, OH (US)

(72) Inventors: Richard K. Williams, Gibsonia, PA (US); Brian Miller, Lower Burrell, PA (US); Frederick F. Tady, Tarentum, PA (US); Suzanne M. Bloom, Pittsburgh, PA (US)

(21) Appl. No.: 17/755,735

(22) PCT Filed: Nov. 6, 2020
(86) PCT No.: PCT/US2020/059528

§ 371 Date: May 6, 2022

Related U.S. Application Data
(60) Provisional application No. 62/933,298, filed on Nov. 8, 2019.

(51) Int. Cl. C08J 11/08; C09D 11/107; C09D 11/103; B65D 23/08; G09F 3/00

(52) U.S. Cl. CPC C08J 11/08; C09D 11/107; C09D 11/103; B65D 23/0878; G09F 3/0291; C08J 2367/02; G09F 2003/0273

(57) ABSTRACT

An ink composition includes a polymeric binder having an addition copolymer and a ketone aldehyde resin. The addition copolymer is chosen from acrylic resins, vinyl resins including copolymers of vinyl chloride and vinyl acetate, and mixtures and combinations thereof. The ink composition further includes a liquid carrier with at least one organic solvent.

### BACKGROUND

The use of polymeric containers, particularly those made from thermoplastic polymers, has been increasing year after year because of their excellent resistance to breakage, lightweight properties, cost, and transparency compared to conventional containers made from glass, metal or other materials. Plastic recycling has become a global environmental concern and is one of the most pressing issues facing the plastic packaging industry today, especially considering the increasing use of single serve containers such as beverage bottles made from polyethylene terephthalate (PET) bottles. For example, many large brand owners have committed to reusing up to 50% recycled PET in single serve containers.

Polymeric food and beverage containers are fitted with different types of exterior labels made from a variety of polymeric materials such as polyesters, polyolefins including polyethylene and polypropylene, polyvinyl chlorides, and the like. For example, shrink wrap films made from polyesters such as PET and derivatives such as PETG and PETC are commonly used to label food and beverage containers. However, while the containers themselves are recyclable, in some cases the shrink wrap films are difficult or expensive to recycle, which results in increasing landfilled waste.

During the recycling process, polymeric labels including inks are removed from the polymeric containers to be reclaimed. When the labelled container is pulverized to form a flake and processed in a wash solution in the recycling process, contamination from the ink on the label can stain the polymeric flake, which can result in a colored recyclable flake material with less potential value for forming new containers, particularly clear containers.

In some examples, a floatable polymeric label material has been used that floats away from the polymeric container material in the caustic wash solution used in the recycling process. This floatable label material is then removed during a float/sink step in the recycling process, which provide a flaked polymeric container material that has more value for downstream container forming processes. Unfortunately, the collected floatable label material often needs to be discarded and along with it, any colorant or ink remains. Even worse, although the floatable label material floats away from the desired flaked container material, colorant or ink present in or on the label often bleeds or dissolves into the one or more wash baths used during the recycling process, which can result in less desirable colored recyclable flake.

Other approaches for recycling of polymeric bottles and their polymeric labels utilizes various separation schemes or alterations to existing recycling equipment processes. Such approaches are limited by the fact that caustic baths held at elevated temperatures, often above 180° F. (80° C.), are needed to wash and rinse the polymeric containers so that collected recyclable polymeric flake free of adhesives and contaminants can be obtained. Colorant or ink present in or on label material is often chemically attacked under such harsh wash conditions, which can result in physical and/or chemical breakdown of the colorant or ink. In the end, the wash baths colorize and stain the polymeric flake, and the discolored recycled polymeric flake is less useful to make new containers.

To address the difficulties encountered in recycling printed polymeric containers and the printed polymeric labels thereon, manufacturers have been required to use polymeric substrates or floatable paper or polymeric label materials that are less receptive to inks and increase costs. Therefore, there is a need to provide an ink composition that is printable on commonly used polymeric container or polymeric label materials to form a durable ink layer that is more readily separable from the container or label during the recycling process.

### SUMMARY

In general, the present disclosure is directed to ink compositions that can be applied or printed onto a polymeric substrate. For example, in some examples the polymeric substrate may be a container for a food or a beverage, and in other examples may be a polymeric film label on a bottle or container. The ink compositions, when dried, form an ink layer that adheres to the polymeric substrate with sufficient bond strength to remain suitably intact during downstream processes requiring application of heat, or mechanical friction encountered during handling or transportation of the container. While having good bond strength to the underlying substrate, the ink layer may be readily removed or separated from the polymeric substrate as the polymeric substrate is recycled.

In one example, which is not intended to be limiting, when the ink layer of the present disclosure is formed on a polymeric container (such as, for example, a PET, PETG or PETC food or beverage container), or on a label thereon, the ink layer is not appreciably soluble in a caustic wash solution used in a recycling process, and as such does not discolor the wash or stain the polymeric flake recovered from the wash steps. Instead, any ink layer separates from the polymeric bottle or label in a form (for example, particulates) that may be filtered out of the wash, which results in a recycled polymeric flake that is less contaminated by the colored ink, and is more likely to be reusable in subsequent molding or extrusion processes. The ink composition of the present disclosure thus provides a more readily recyclable polymeric container or polymeric label.

In one aspect, the present disclosure is directed to an ink composition including a polymeric binder with an addition copolymer and a ketone aldehyde resin. The addition copolymer is chosen from acrylic resins, vinyl resins comprising copolymers of vinyl chloride and vinyl acetate, and mixtures and combinations thereof. The ink composition further includes a liquid carrier with at least one organic solvent.

In another aspect, the present disclosure is directed to a label including an ink layer disposed on a polymeric film. At least about 80 weight % of the ink layer includes at least one pigment and a polymeric binder, the polymeric binder including an addition copolymer and a ketone aldehyde resin. The addition copolymer is chosen from acrylic resins, vinyl resins comprising copolymers of vinyl chloride and vinyl acetate, and mixtures and combinations thereof.

In another aspect, the present disclosure is directed to a method including applying on a polymeric label an ink composition. The ink composition includes a polymeric binder having an addition copolymer and a ketone aldehyde resin. The addition copolymer is chosen from acrylic resins, vinyl resins comprising copolymers of vinyl chloride and vinyl acetate, and mixtures and combinations thereof. The ink composition further includes a liquid carrier including at least one organic solvent.

In another aspect, the present disclosure is directed to a method for recycling a polymeric food or beverage container. The container has an ink layer on a surface of the container or on a label affixed to the container. The method includes pulverizing a plurality of the container and any labels thereon to form a mixture of flakes, wherein at least a portion of the flakes include the ink layer. The ink layer includes at least one pigment and a polymeric binder, the polymeric binder including an addition copolymer and a ketone aldehyde resin, wherein the addition copolymer is chosen from acrylic resins, vinyl resins comprising copolymers of vinyl chloride and vinyl acetate, and mixtures and combinations thereof; placing the flakes in an aqueous alkaline wash bath, wherein the wash bath has a temperature of about 75° C. to about 85° C.; separating at least about 95 wt % of the ink layer from the portion of the flakes having the ink layer such that the ink layer forms ink particulates that are insoluble in the water bath and both the wash bath and the flakes therein are substantially untinted; removing the untinted flakes from the wash bath; and recycling the untinted flakes to form recycled food or beverage containers.

Herein, the term “comprises,” and variations thereof, do not have a limiting meaning where these terms appear in the description and embodiments. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the embodiments, and the equivalents of those structures. Any of the elements that are positively recited in this specification as alternatives may be explicitly included in the embodiments or excluded from the embodiments, in any combination as desired. Although various theories and possible mechanisms may have been discussed herein, in no event should such discussions serve to limit the embodimentable subject matter.

### DETAILED DESCRIPTION

In one aspect, the present disclosure is directed to an ink composition suitable for application to a polymeric substrate. The ink composition includes a polymeric binder including an addition polymer or copolymer and a ketonic resin, a liquid carrier, and an optional colorant.

The addition polymer in the polymeric binder of the ink composition can include a polymer or copolymer that forms by linking of simple monomeric units without the co-generation of other products. In some examples, which are not intended to be limiting, addition polymers can be formed by chain polymerization, when the polymer is formed by the sequential addition of monomer units to an active site in a chain reaction, or by polyaddition, when the polymer is formed by addition reactions between species of all degrees of polymerization. In some non-limiting examples, the addition polymerization mainly can take place by a free radical mechanism including three steps, initiation of a free radical, chain propagation, and chain termination.

The terms “addition polymer” and “addition copolymers” are generally used interchangeably herein, although typically the addition polymers employed will in fact be copolymers (viz., polymers formed from two or more chemically different monomers).

Suitable addition copolymers include poly(vinyl chloride) copolymers, acrylic copolymers, vinyl copolymers, and polyolefin copolymers (e.g., polyethylene, polypropylene, and copolymers thereof, and mixtures and combinations thereof.

The addition copolymer used in the ink compositions of the present disclosure may be made using unsaturated compounds including one or more olefinic double bonds (e.g., alpha-olefin double bonds). Suitable unsaturated compounds may be of low (monomeric) or high (oligomeric) molecular mass. Examples of monomers containing a suitable double bond are alkyl, hydroxyalkyl, cycloalkyl (which optionally interrupted by O) or amino acrylates, or alkyl, hydroxyalkyl, cycloalkyl (which optionally interrupted by O) or amino methacrylates, for example methyl, ethyl, butyl, 2-ethylhexyl or 2-hydroxyethyl acrylate, tetrahydrofurfuryl acrylate, isobornyl acrylate, methyl methacrylate, cyclohexyl methacrylate or ethyl methacrylate. Silicone acrylates are also advantageous. Other examples are acrylonitrile, acrylamide, methacrylamide, N-substituted (meth)acrylamides, vinyl esters such as vinyl acetate, vinyl ethers such as isobutyl vinyl ether, styrene, alkyl- and halostyrenes, N-vinylpyrrolidone, vinyl chloride or vinylidene chloride.

Examples of monomers containing two or more double bonds (i.e., multi-ethylenically unsaturated monomers) are the diacrylates of ethylene glycol, propylene glycol, butylene glycol, neopentyl glycol, or hexamethylene glycol, and 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl) isocyanurate.

The one or more monomers used to make the addition copolymers of the present disclosure may include one or more acid-functional monomers, which in some cases may be carboxyl-functional. Examples of unsaturated carboxylic acids are acrylic acid and methacrylic acid, which may be referred to herein collectively as (meth)acrylic acid, crotonic acid, itaconic acid, and cinnamic acid, as well as other unsaturated fatty acids such as linolenic acid or oleic acid.

In some examples, suitable monomers for making the additional polymers are multifunctional, and can include trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol, and mixtures and combinations thereof.

Examples of other monomers suitable for making the addition polymer include unsaturated amides such as methylenebisacrylamide, 1,6-hexamethylenebisacrylamide, diethylenetriaminetrismethacrylamide, bis(methacrylamidopropoxy)ethane, β-methacrylamidoethyl methacrylate and N-[(β-hydroxyethoxy)ethyl]acrylamide.

Examples of suitable vinyl resins include copolymers of vinyl chloride and vinyl acetate, optionally including one more additional comonomers. In some examples, the copolymer includes about 5 weight percent (wt %) to 50 wt % vinyl acetate, or about 5 wt % to about 25 wt %, or about 5 wt % to about 15 wt %, based on the total weight of the copolymer. In some examples, the vinyl resins include about 95 wt % to about 50 wt % vinyl chloride, or about 90 wt % to about 60 wt %, or about 85 wt % to about 70 wt %.

In some embodiments, the comonomers in the vinyl resins include hydroxy or acid groups. For example, hydroxy or acid groups can be incorporated into the copolymers of vinyl chloride and vinyl acetate by partial hydrolysis of the vinyl acetate or copolymerization with maleic anhydride and hydroxy-functional (meth)acrylic monomers, respectively. In some embodiments, the optional acid groups include, for example, carboxylic acids, maleic acid, and the like, which are typically present at about 0.5 wt % to about 5 wt %, or about 1 wt % to about 3 wt %, or about 1 wt % to about 2 wt %, based on the total weight of the resin.

In some examples, the vinyl resins are terpolymers including vinyl chloride, vinyl acetate, and a dicarboxylic acid available under the trade designation VINNOL H from Wacker Chemic, Munich, Del., or terpolymers of vinyl chloride, vinyl acetate and maleic acid available under the trade designation UMCH from Wuxi Honghui Chemical Co., Wuxi City, Conn. Other suitable vinyl resins include those sold under the trade designations VINYLYTE (copolymers of vinyl chloride and vinyl acetate) and UCAR VYNC-P (vinyl chloride, vinyl acetate, and hydroxy alkyl acrylate) available from Union Carbide, Houston, Tex.), and SOLVIC (polyvinyl chloride resins and latexes available from Westlake Chemicals, Houston, Tex.).

Suitable copolymers and terpolymers can be prepared using solution or suspension polymerization techniques.

In some examples, suitable vinyl resins have a molecular weight M_{w} of about 20,000 to about 150,000, or about 50,000 to about 110,000 or about 60,000 to about 80,000, as determined by, for example, gel permeation chromatography. In some cases, a lower molecular weight can provide the ink composition with better print properties.

While not wishing to be bound by any theory, currently available evidence indicates that the glass transition temperature (Tg) or softening point of the components of the ink composition (e.g., one or both of the addition copolymer and the ketonic resin) may allow the ink to more readily form particulates and separate from the polymeric substrate during a recycling process. The term “softening point” means the temperature at which a polymer passes from a solid to a liquid state, i.e. in amorphous polymers, the softening point corresponds to the glass transition temperature, and in (partially) crystallized polymers, it corresponds to the melting point. For example, during some recycling processes for PET containers and labels, the temperature of the caustic wash that is used to remove the ink from the film is typically about 170° F. to about 180° F. (about 75° C. to about 80° C.).

In various embodiments, the vinyl resin can have a glass transition temperature (Tg) of about 25° C. to about 90° C., or about 40° C. to about 80° C., or about 70° C. to about 80° C., which can reduce the tendency of the ink composition to hydrolyze or go into solution in the caustic wash solution. In some examples, the Tg may be determined by DSC (differential scanning calorimetry) using an analytical instrument available under the trade designation DSC from Mettler Toledo, Columbus, Ohio.

In various embodiments, which are provided as examples, the vinyl resin has a hydroxyl value at least about 100, or at least about 150, or at least about 200 to up to about 350, or up to about 250. Hydroxyl value may be measured according to ASTM D1957-86 (Reapproved 2001) entitled “Standard Test Method for Hydroxyl Value of Fatty 30 Oils and Acids” and available from the American Society for Testing and Materials International of West Conshohocken, Pa.

In various embodiments, the vinyl resin has an acid number of less than about 300 mg KOH/g, or less than about 100 mg KOH/g, or less than about 10 mg KOH/g, or less than about 7.5 mg KOH/g, or less than about 6 mg KOH/g, as measured according to, for example, ASTM D1045.

In some embodiments, the addition polymer or copolymer is an acrylic polymer or copolymer with a M_{w} of about 20,000 to about 120,000, or about 12,000 to about 110,000, or about 12,000 to about 55,000, or about 55,000 to about 110,000. Suitable acrylic resins include, but are not limited to, homopolymers and copolymers of (meth)acrylic acid, wherein (meth)acrylic acid includes acrylic and methacrylic, esters of acrylic acid, esters of methacrylic acid, acrylamides, and methacrylamides. In various embodiments, which are not intended to be limiting, the acrylic resin is an alkyl methacrylate such as, for example, butyl methacrylate, or an alkyl methacrylate copolymer such as, for example, a copolymer of butyl methacrylate and methyl methacrylate.

Some suitable acrylic resins have a Tg (by differential scanning calorimetry (DSC)) of about 40° C. to about 90° C., or about 45° C. to about 70° C., or about 45° C. to about 65° C. Suitable acrylic resins have an acid number of less than about 1 mg KOH/g resin to about 100 mg KOH/g resin, or less than 1 mg KOH/g resin to about 10 mg KOH/g resin, or less than about 1 mg KOH/g resin to about 6 mg KOH/g resin. In some examples, which are not intended to be limiting, suitable acrylic resins may include those with a combination of properties such as a Tg from about 45° C. to about 65° C., an acid number of less than about 1 to about 6 mg KOH/g, and a M_{w} of about 55,00 to about 110,000. Suitable commercially available acrylic resins include, but are not limited to, those available under the trade designation NEOCRYL from DSM Coating Resins, Heerlen, Netherlands, and NEOCRYL B-725 and B-842 have been found to be particularly useful.

In various examples, the polymeric binder component of the ink composition includes about 5 wt % to 60 wt % of the addition copolymer. In some examples, the addition copolymer is present in the polymeric binder component at about 10 wt % to about 60 wt %, or about 20 wt % to about 60 wt %, or about 30 wt % to about 60 wt %, or about 40 wt % to about 55 wt %.

The polymeric binder component of the ink compositions of the present disclosure further includes at least one ketonic resin. In one embodiment, the ketonic resin is a ketone-aldehyde resin that is a reaction product of ketones or mixtures of ketones and aldehydes. In some examples, the ketone-aldehyde resin is a resinous product of a condensation reaction of various ketone molecules with aldehydes.

Suitable ketones for the ketone-aldehyde resins may include cyclic ketones, aliphatic ketones, or combinations thereof. Cyclic ketones are presently preferred, with cyclohexanone being an example of a presently preferred cyclic ketone. Examples of suitable ketones may include acetone, acetophenone, methyl ethyl ketone, 2-heptanone, 3-pentanone, methyl isobutyl ketone, cyclopentanone, cyclododecanone, mixtures of 2,2,4- and 2,4,4-tri-methylcyclopentanone, cycloheptanone, and cyclooctanone, cyclohexanone and all alkyl-substituted cyclohexanones having one or more alkyl radicals containing in total from 1 to 8 carbon atoms, individually or in a mixture. Examples of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone.

Suitable aldehydes may include branched or nonbranched aldehydes, such as formaldehyde, acetaldehyde, n-butyraldehyde and/or isobutyraldehyde, valeraldehyde, and dodecanal, and the like, although it is possible to use any aldehydes reported in the literature to be suitable for ketone resin syntheses. In some examples, any form a formaldehyde may be used, and suitable materials include para-formaldehyde or trioxane. Aromatic aldehydes, such as, for example, benzaldehyde, may likewise be present in a mixture with the formaldehyde.

In some embodiments, which are not intended to be limiting and are provided as an example, suitable ketonic resins include cyclohexanone—formaldehyde resins.

While not wishing to be bound by any theory, currently available evidence indicates that the softening point of suitable ketonic resins should be about equal to the temperature of the caustic wash solution used in the recycling process for polymeric food or beverage containers, which can reduce the tendency of the ink composition to hydrolyzes or go into solution in the caustic wash solution. In various embodiments, suitable ketonic resins have a softening point of about 75° C. to about 120° C., or about 75° C. to about 115° C., or about 75° C. to about 95° C.

In some example embodiments, which are not intended to be limiting, the ketonic resins used in the ink compositions of the present disclosure may have an hydroxyl value of at least 80, at least 100, at least 150, or at least 200 mg KOH/g resin. Typically, the ketonic resin will have a hydroxyl value of less than 350, less than 300, or less than 250 mg KOH/g resin. In some embodiments, suitable ketonic resins are used that have a hydroxyl value between 150 and 250 mg KOH g/resin. An example of a suitable method for determining hydroxyl value is that of ASTM D1957-86 (Reapproved 2001) entitled “Standard Test Method for Hydroxyl Value of Fatty Oils and Acids” and available from the American Society for Testing and Materials International of West Conshohocken, Pa.

Suitable ketone-aldehyde resins include, but are not limited to, those available under the trade designation KTR-100 from Suparna Chemicals Limited of Mumbai, India (softening range of 95-105° C.); those available under the trade designation HK-100 from Aakash Chemicals of Glendale Heights, Ill. (softening range of 92-102° C.); those available under the trade designations TEGO VARIPLUS SK (softening point of approximately 115° C., DIN 53181), TEGO VARIPLUS 1201 TF (softening point of approximately 162° C., DIN 53181), and TEGO VARIPLUS DS 50 (for waterborne embodiments; softening point of approximately 150° C., DIN 53181) from Evonik Industries, Essen, Del. The above softening points are the values provided in the literature by the suppliers of the products. For commercial products with softening points or ranges reported by the supplier or manufacturer, it is not necessary to determine the values as described below. Rather, the manufacturer's reported values may be used. Examples of suitable ketonic resins and methods for making them are set forth in Naidu, Development of Ketonic Resin by Polymerization Reaction: A Critical Review, Polymer 61 (2015) 204-212, which is incorporated herein by reference in its entirety.

In some embodiments, the total amount of ketonic resin as a percentage by weight of the polymeric binder component can be, e.g., between from about 95% to about 40%, or about 90 wt % to about 45 wt %.

In various embodiments, which are not intended to be limiting and are provided by way of an example, the ratio by weight of the addition copolymer to the ketonic resin in the polymeric binder component of the ink composition is about 10 to about 60, or about 60 to about 40, or about 55 to about 45, but this ratio can vary depending on the softening point of the ketonic resin and Tg or softening point of the addition polymer. For example, the ratio can change if a ketonic resin is used that is higher in softening point or the addition polymer is higher in Tg. Ketonic resins have a relatively low softening point, and excess ketonic resin may cause the ink to be excessively soft.

In some embodiments, the polymeric binder component consists essentially of the addition polymer and the ketonic resin. In this application the term consists essentially means that the polymeric binder includes the addition polymer, the ketonic resin, and other compounds that do not impact the basic and novel properties of the polymeric binder. In some examples, the polymeric binder consists of the addition polymer and the ketonic resin, which in this application means that the polymeric binder includes only the addition polymer and the ketonic resin. In embodiments in which the polymeric binder component includes a liquid carrier, the amount of the liquid carrier in the polymeric binder will be added to the amount of other liquid carrier in the ink composition to provide an overall amount of liquid carrier in the ink composition.

In some embodiments, the ink compositions of the present disclosure can include an optional colorant, which provide color to a substrate by altering its reflective characteristics. In various embodiments, the colorant can be organic or inorganic pigments or combinations thereof, or inorganic or organic dyes, suitable for solvent coatings and inks.

Examples of suitable colorants include, but are not limited to, organic pigments such as pigment yellow numbers 12, 13, 14, 17, 74, 115; pigment red numbers 2, 22, 23, 48:1, 48:2, 52, 53, 57:1, 122, 116, 170, 259, 266; pigment orange numbers 5, 16, 34, 36; pigment blue numbers 15, 15:1, 15:3, 15:4; pigment violet numbers 3, 23, 27; and pigment green number 7. Examples of inorganic pigments include, but are not limited to, iron oxides, titanium dioxides, chromium oxides, ferric ammonium ferrocyanides, ferric oxide blacks, pigment black number 7, and pigment white numbers 6 and 7.

In some embodiments, the pigments are chemically resistant, which in this application refers to pigments with a solvent fastness rating of at least 3 on a 5 point rating scale, or at least 4 on a 5 point scale. The solvent fastness rating, which is provided by pigment suppliers, refers to the resistance of the pigment to exposure to an organic solvent such as ethanol. While not wishing to be bound by any theory, currently available evidence indicates that pigments with a solvent fastness rating of at least 3 are more difficult to solubilize in the hot caustic water bath used in recycling processes for food and beverage containers, and can help to provide an ink composition that forms particulate-like matter when exposed to the wash process.

In some embodiments, the pigment or colorant is a color additive FDA approved for safety in human foods, drugs, cosmetics and medical devices as defined in 21 C.F.R. parts, 73-74 and 81-82.

In some examples, the ink compositions may optionally contain a specialized colorant, such as a dye, a pigment, a taggant, or a fluorophore, which can be used to visualize the deposition or warn end users about the presence of a special de-seaming coating on the label.

In some embodiments, the ink composition can be free of colorant, and can form a slip, gloss or matte coating. In various embodiments, the colorant-free ink compositions can be applied on a polymeric label, or over a colored ink on a polymeric label.

In various embodiments, the ink compositions of the present disclosure include colorant in an amount, based on the total weight of the ink compositions, from about 0 wt % to about 25 wt %, or about 3 wt % to about 15 wt %.

The ink compositions further include a liquid carrier suitable for use with resins, pigments and other additives, or to adjust the viscosity of the ink composition. Suitable liquid carriers include, but are not limited to, aqueous solvents, water, or non-aqueous organic solvents such as hydrocarbons. In various embodiments, the ink composition includes about 50 wt % to about 95 wt % of the liquid carrier, or about 60 wt % to about 80 wt %, based on the total weight of the ink composition.

Suitable organic solvents for the liquid carrier include, but are not limited to, heptanes, hexanes and pentanes; cyclic hydrocarbons and substituted cyclic hydrocarbons, such as ethylcyclohexane; petroleum distillates, such as naphtha, petroleum ether and light aliphatic solvents; aromatic compounds, such as xylene and toluene; acetates such as, for example, alkyl acetates, as ethyl acetate, isopropyl acetate, butyl acetate, propylene glycol monomethyl ether acetate (PM acetate) and n-propyl acetate; glycols and glycol ethers, such as monopropylene glycol, dipropylene glycol, 1-ethoxy-2-propanol, 1-propoxy-propanol (PROPOSOL solvent P), propylene glycol n-propyl ether, n-butyl ether, diethylene glycol monobutyl ether, propylene glycol methyl ether and diacetone alcohol; and alcohols, such as butyl alcohol, ethanol, propanol, isopropanol and n-propanol.

The liquid carrier may include a single solvent, or may include a mixture of solvents. In one example, which is not intended to be limiting, the ink compositions of the present disclosure can include a mixture of solvents such as a hydrocarbon, a petroleum distillate and an alkyl acetate. Exemplary solvents used in the ink compositions provided herein are heptane, naphtha and n-propyl acetate.

In some embodiments, the liquid carrier can include about 1 wt % to about 80 wt % of an organic solvent, or about 1 wt % to about 60 wt %, or at least about 20 wt %, or at least about 50 wt %, or at least about 80 wt %, of an organic solvent.

In some embodiments, the organic solvent in the liquid carrier is an alcohol including, but not limited to, butyl alcohol, ethanol, propanol, isopropanol, n-propanol, and mixtures and combinations thereof. In some embodiments, the solvent in the liquid carrier may include an alkyl acetate, which may be present in the liquid carrier in an amount up to about 80 wt %, based on the total weight of the liquid carrier.

In some embodiments, the ink composition can include optional additives such as one or more waxes. Suitable waxes for use in the compositions provided herein include natural waxes or synthetic waxes. Exemplary natural waxes include, but are not limited to, plant waxes, such as carnauba waxes, animal waxes, fossil waxes and petroleum waxes. Exemplary synthetic waxes include, but are not limited to, polyolefin waxes such as polyethylene waxes, polytetrafluoroethylene and fatty acid amide waxes. Suitable commercially available waxes include, but are not limited to, those available under the trade designations S-390-C polyethylene wax from Shamrock Technologies, Newark, N.J., TEFLON from Chemours Co., Wilmington, Del. and CRODAMIDE ER from Croda, Inc., New Castle, Del.

Generally, waxes are used in amounts that will not make up more than at or about 15 wt % of the total weight of the ink composition, and often can be used in amounts that will not make up more than at or about 10 wt % of the total ink composition. In some embodiments, one or more waxes are present in an amount from about 0.1% wt to about 10 wt %, based on the total weight of the ink composition.

The ink compositions provided herein can optionally include additional additives to enhance its properties such as, for example, adhesion, film formation, hardness, scuff resistance, shrinkability, flexibility, heat resistance, block resistance, crinkle resistance, scratch resistance and opacity. Suitable optional additives include, but are not limited to, surfactants, coalescents, plasticizers, silicones, stabilizers, dispersion auxiliaries, emulsifiers, antioxidants, e.g. 2,2-thiobis(4-methyl-6-t-butylphenol) or 2,6-di-t-butylphenol, light stabilizers, fillers such as glass or alumina, for example talc, gypsum, silicic acid, rutile, carbon black, zinc oxide, iron oxides, reaction accelerators, levelling agents, lubricants, wetting agents, thickeners, flatting agents, antifoamers and other auxiliaries customary in paint technology. Suitable dispersion auxiliaries are water-soluble organic compounds which are of high molecular mass and contain polar groups, examples being polyvinyl alcohols, polyvinylpyrrolidone or cellulose ethers. Emulsifiers which can be used are nonionic emulsifiers and, if desired, ionic emulsifiers as well.

In some example embodiments, which are not intended to be limiting, the ink composition has a Zahn #2 cup viscosity at 25° C. of about 16 seconds to about 40 seconds, or about 16 seconds to about 32 seconds. A suitable method for measuring the viscosity of the ink composition is set forth in the working examples below.

In some example embodiments, the ink composition includes about 5 wt % to about 50 wt % of polymeric binder including an addition copolymer and a ketonic resin; and about 50 wt % to about 95 wt % of a liquid carrier, wherein the liquid carrier includes at least one organic solvent, and about 0 wt % to about 25 wt % of at least one pigment. In another example, the ink composition includes about 3 wt % to about 15 wt % pigment. In some embodiments, the ink may be formulated as a clear slip coating with 0 wt % colorant and having resin solids as high as 25% when applied at a press viscosity defined as 17-22 seconds in a #2 Zahn cup.

In some embodiments, the ink composition is free of halogens or halogen-containing compounds. In some embodiments, the ink composition is essentially free of halogens or halogen-containing compounds, which in this application means that the ink composition includes less than about 0.01 wt % of halogens or halogen-containing compounds. In some embodiments, the ink composition is substantially free of halogens or halogen-containing compounds, which in this application means that the ink composition includes less than about 1 wt % of halogens or halogen-containing compounds.

The ink compositions of the present disclosure can be applied to at least one surface of a polymeric substrate such as a food or beverage container, or to at least one surface of a polymeric label for a polymeric food or beverage container, in any desirable manner. Examples include, but are not limited to, roller, slot die, knife, doctor blade, spin, curtain, dip, flow, rotary screen, extrusion, hot melt, brush or rod coating, spraying, wicking, sprinkling, or electrophoresis, or via a printing process such as gravure, flexographic, screen, lithographic, or digital. The properties of the ink composition may be adjusted to the rheology required for proper deposition for a particular technique.

In some example embodiments, which are not intended to be limiting, the as-applied ink layers have a thickness of about 0.5 microns to about 50 microns, or about 1 micron to about 35 microns, or about 5 microns to about 25 microns, or about 25 microns to about 35 microns. Additional ink layers can be applied based upon the desired properties of the finished film product. The ink layer may be a single layer or may include multiple layers. In various embodiments, which are not intended to be limiting and are provided as an example, the ink layer includes 1 to 20 layers, or 1 to 15 layers, or 1 to 14 layers.

The applied ink composition may then be hardened to form an ink layer on the polymeric substrate. For example, in some embodiments the ink layer includes at least about 80 wt % of pigment and polymeric binder, based on the total weight of the ink layer, or at least about 90 wt %, or at least about 95 wt %.

A typical drying schedule for the ink composition to form the ink layer can be at or about room temperature, or at or about 50° C., or at or about 80° C., for at least about 1 second, or at least about 1.5 seconds, or at least about 5 seconds, but other drying temperature and times are possible depending on substrate, press speeds, and capabilities. Generally, the drying will be such that the printed film is not subject to heat distortion. To prevent distortion, the drying temperature/time is generally about 80° C. or lower for about 1 second to about 30 seconds.

The dry coating weight of the ink layer depends on the deposition technique used, but will generally be about 0.1 to about 10 g/m² dry (i.e. grams of applied ink composition, after drying, per square meter of coated substrate), or about 0.1 to about 2.5 g/m², or about 1 to about 6 g/m², or about 1.5 to about 4 g/m².

To ensure that a printed polymeric food or beverage container or printed polymeric label may be handled, fitted, shipped, stacked, rubbed against adjacent containers, and the like, in some example embodiments, the dried ink layer has a coefficient of friction at or below 0.3, or between 0.10 and 0.40, or between 0.15 and 0.35.

In some embodiments, the dried ink layer is readily removable from the polymeric substrate and forms particulates in an alkaline hot water bath with a temperature of about 75° C. to about 80° C. For example, the ink layer may be readily removed in the alkaline hot water bath from a polymeric container having the ink layer thereon, or from a polymeric label having the ink layer thereon, to more efficiently recycle at least one of the polymeric container or the polymeric label. In some embodiments, at least about 80 wt %, or at least about 90 wt %, or at least about 95 wt %, or at least about 99 wt %, of the ink layer separates from the polymeric substrate when the polymeric substrate is heated in an alkaline water bath at a temperature of about 65° C. to about 95° C., or about 75° C. to about 85° C. In various embodiments, the alkaline water bath has a pH greater than about 12, or greater than about 13, or about 13.3 to 13.5.

In some embodiments, the ink layer is applied directly on an interior or an exterior surface of a food or beverage container. In some examples, the ink layer can be applied on a surface of a beverage bottle such as a single use or single serve beverage bottle. For example, single use beverage bottles made from PET or PET derivatives such as PETG and PETC can have sizes such as 8 oz., 12 oz., 16.9 oz., 20 oz., 23.7 oz., or 33.8 oz, or sizes such as 500 ml, 750 ml, 1 liter, 1.5 liter, 2 liter, 3 liter, and the like. As one example, single use beverage bottles may be filled with any consumer type of drink including water, vitamin-containing water, sports drinks, protein drinks, and the like.

In some embodiments, the single use bottles may contain a 1.0 wt % or lower content of a cyclic trimeric oligomer of ethylene terephthalate, or 0.7 wt % or lower, or 0.6 wt or lower, or 0.5 wt % or lower. If the content is higher than 1.0 wt %, the cyclic trimeric oligomer content is increased when the bottle is collected and recycled into polymer pellets without removing the label, so that the molds or nozzles used in the spinning, extrusion, injection, or any other molding of the recycled polymer pellets may often be fouled with these oligomers and the products may often be stained with these oligomers to lower their quality.

In some embodiments, the polymeric substrate is a polymeric label, which is widely used in the packaging industry. Flexible plastic films suitable for the polymeric labels can vary widely, and some examples of suitable polymeric materials, which is not intended to be limiting, include polyolefin films such as polypropylene, polyethylene, polyethylene napthalate (PEN) and PET films, oriented polystyrene, nylon, polyvinyl chloride, non-woven film substrates, and the like. In various embodiments, the polymeric films may be a single layer, or may include multiple layers of the same or different polymeric materials.

Compared to more rigid plastic substrates, polyolefin films used in packaging are typically much thinner and more flexible, and acceptable adhesion of an ink or coating to these plastic films is important in packaging applications. It can be difficult to achieve satisfactory adhesion of known coatings or inks, such as water and solvent-based inks, to the surface of the untreated polypropylene and polyethylene films because these polymeric materials have low surface energy and low polarity. In some embodiments, the surfaces of the label stock may optionally be treated to improve printability by methods such as corona, plasma or flame treatment, or chemical treatments such as applying a coating or primer. In some case, the surface treatments soften or ionize the surface of polyolefins and make the surface temporarily printable. However, in some cases the ink or coating composition is applied directly to an untreated flexible polyolefin film without the need for an initial surface treatment step.

The polymeric label may be applied to a polymeric food or beverage container by shrink-wrapping the label about the container, or by attaching the label to the beverage container with an adhesive. Shrink wrap films used to label polymeric beverage containers such as PET bottles are commonly referred to as body sleeve labels, sleeve labels or shrink sleeves. In various examples, the films may include polyesters, or may include other polymeric materials, and are formulated for outer sleeve wrapping and label applications on plastic bottles including, but not limited to, bottles made from PET, PETG, PETC and the like, or made from polyesters such as PET and its derivatives. In some examples, useful shrink wrap labels made from PET or PET derivatives may have a shrinkability of about 30% to about 80%.

In some examples, the polymeric shrink-wrap labels include PETG, which has a higher density than the PET or the PET derivative used in the underlying beverage container. This difference in density can hinder separation of the containers and labels in sink/floatation tanks typically utilized in recycling steps. In one embodiment, to reduce the density of the PETG label film, voids may be created in the film by incorporating a blowing agent in the entire film, or in the area overlain by the ink layer. Several film/resin suppliers, including Exxon, Toppas, and Cryovac, or converters such as Fujiseal, have introduced low density films or co-extruded film structures with low density (below 1.0 or at least below 1.05), to address the shrink sleeve separation issue. Such films are generally based on mono- or multi-layer structures including polymers built around a low density core, such as polyolefins, or micro-voided/cavitated polymer, optionally wrapped by a PETG skin, and, if needed, a tie layer between the core and the PETG. The overall density of the film is designed to make it floatable in the sink/floatation tank.

The present disclosure also provides methods that include causing the ink composition to be used on the polymeric label (e.g., a shrink-fit label) of a single-serve plastic container such as, e.g., any of the plastic containers disclosed herein, and especially single-serve beverage containers. In some cases where multiple parties are involved, a first party (e.g., the party that manufactures and/or supplies the ink composition) may provide instructions, recommendations, or other disclosures about the single-serve plastic labelling end use to a second party (e.g., a label maker, coater, or supplier; a manufacturer of such containers or preforms for forming such containers; a brand owner that packages its product in such containers; or a recycler of such containers). Such disclosures may include, for example, instructions, recommendations, or other disclosures relating to applying ink compositions to labels for subsequent use on single-serve plastic containers, preparing ink compositions for such uses, cure conditions or process-related conditions for such compositions, or recycling single-serve plastic containers including labels bearing the ink compositions. Such disclosures may occur, for example, in technical data sheets (TDSs), safety data sheets (SDSs), regulatory disclosures, warranties or warranty limitation statements, marketing literature or presentations, or on company websites. A first party making such disclosures to a second party shall be deemed to have caused the ink compositions to be used on a label of a plastic container even if it is the second party that actually applies the ink composition to a label in commerce, uses such inked labels in commerce on a single-serve plastic container, and/or fills such labelled containers with product.

As noted above, the ink layer on the polymeric labels of the present disclosure adheres to the polymeric film labels and is sufficiently durable to remain adhered as the label is applied to a polymeric food or beverage container, and handled during packaging, transportation, and use by the consumer. However, when the food or beverage container with the attached label is recycled, the ink layer is removable from the label when the container or the label is immersed in alkaline hot water. While not wishing to be bound by any theory, presently available evidence indicates that the ink layer separates from the surface of the label and forms particulates, and does not go into solution in the alkaline wash solution.

The present disclosure is further directed to a method for recycling a polymeric food or beverage container such as, for example, a single serve beverage container. The container may have an ink layer applied directly on one or more surfaces thereof, or may include a polymeric label having an ink layer on one or more surfaces thereof, or may include ink layers on the surfaces of both the container and the label. In some cases, the label may be a shrink-fit label on a single serve beverage container such as, for example, a PET beverage bottle.

The recycling method of the present disclosure includes a pulverizing the polymeric food or beverage containers alone or along with the attached polymeric labels to form a mixture of small flake-like particles. If the ink layer is applied directly on a surface of the polymeric container, at least some of the flakes include the polymeric container materials with the ink layer. If the ink layer is applied on a surface of the polymeric label on the polymeric container, the mixture of flakes includes a first portion derived from the polymeric container, a second portion derived from the polymeric labels, and a third port portion derived from the polymeric container with attached polymeric labels. At least some of the polymeric labels in the third portion include the ink layer.

The mixture of flakes is then placed in an alkaline hot water bath with a temperature of about 75° C. to about 85° C. and agitated. In some embodiments, which are not intended to be limiting, the alkaline hot water bath include about 1 wt % to about 10 wt % NaOH, or about 1 wt % to about 5 wt % NaOH, and has a pH of about 12 to about 14. During the heating and stirring step, the polymeric label materials separate in the water bath. For example, in some embodiments, the polymeric label materials are less dense than the polymeric container materials and float on a surface of the water bath.

During the heating step, at least about 80 wt %, or at least about 90 wt %, or at least about 95 wt %, or at least about 99 wt %, or even 100 wt %, of the ink layer also separates from the polymeric container materials and polymeric label materials. The ink layer forms ink particulates that do not go into solution in the water bath. In some examples, the ink particulates float to the surface of the water bath, or sink to the bottom of the water bath. Since the ink layer does not dissolve and go into solution in the hot water bath, the ink does not discolor or otherwise contaminate the water bath, the flakes of the polymeric container material, or the flakes of the polymeric label material. In some embodiments, for example, the separation of the ink layer does not discolor the wash solution when the wash solution is viewed with the naked eye.

The flakes of the polymeric label material and the flakes of the polymeric container can then be removed from the water bath. The flakes include no ink from the ink layer, or substantially no ink from the ink layer, and thus remain at least substantially similar to their original color. All or a portion of the uncontaminated flakes can be re-used for container making, label making, and the like.

Embodiments of the present invention will now be described with reference to the following non-limiting examples.

### Examples

The materials used in the examples below are shown in the following table.

MATERIALS

| | |
|---|---|
| S-395 N1 | Finely ground, crystalline grade of polyethylene wax, Specific Gravity = |
| | 0.95 g/cm³; Particle Size Mean Value = 4-6 μm; NPIRI Grind = 2.5 max. |
| | NGrind; Hegman Grind = 6.5-7.0 DSC Melting Point = 259/126° F./° C.) - |
| | Shamrock Technologies, Inc. (Newark, NJ) |
| SOLSPERSE | 100% active polymeric dispersant, Flash Point = 200° C.; Boiling Point = |
| 20000 | decomposes without boiling >250° C.; Specific Gravity = 1.02 g/cm³) - |
| | Lubrizol Advanced Materials, Inc. (Brecksville, OH) |
| 5090 Pthalo | Green Shade Pthalocyanine Blue Pigment, pH (10% Aqueous Slurry) = |
| Blue 15:3 | 5.0-7.5, Moisture Content <1.0%, Oil Absorption (g oil/100 g) = 1.60, |
| | Lightfastness (1-8) Full Shade = 8 Tint = 8, Chemical Resistance (1-5) |
| | Acid = 5 Alkali = 5) - Lansco Colors (Pearl River, NY) |
| Special Black | Carbon Black Pigment, Blackness Value M (DIN 55979) = 244; Oil |
| #4 Powder | absorption number (ASTM 2414) = 115 ml/100 g; Average primary |
| | particle size = 25 nm) - Orion Engineered Carbons LLC (Kingwood, TX) |
| Isopropanol | Specific Gravity 20°/20° C. (D-268) = 0.785-0.787 cm³; Distillation, ° C. |
| 99% | (D-1078) = 1.5 range to 82.3; Acidity, % by wt, as Acetic Acid (D-1613) = |
| | 0.002 max; Water, % by wt (D-1364) = 0.1 max; Nonvolatiles, mg/100 |
| | ml (D-1353) 5 max; Color, Pt—Co (D-1209) = 5 max; Water Miscibility |
| | (D-1722) = passes test; Assay = 99.8 min) - Nexeo Solutions (Dublin, OH) |
| n-Butyl Acetate | Normal 99.5%, Specific Gravity, 20°/20° C. (D-268) = 0.882-0.884 |
| | g/cm³; Purity, wt % = 99.5 min; Alcohol, wt. % = 0.5 max; Acidity, wt %, |
| | as Acetic Acid (D-1613) = 0.01 max; Non-volatiles, g/100 ml (D-1353) = |
| | 0.005 max; Color, Pt—Co (D-1209) = 10 max; Water, wt % (D-3621) = |
| | 0.05 max) Nexeo Solutions (Dublin, OH) |
| n-Propyl | Propyl Acetate Normal 99.5%, Specific Gravity, 20°/20° C. (D-268) = |
| Acetate | 0.882-0.884 g/cm³; Purity, wt % = 99.5 min; n-propanol, wt. % = 0.5 |
| | max; Acidity, wt %, as Acetic Acid (D-1613) = 0.01 max; Color, Pt—Co |
| | (D-1209) = 15 max; Water, wt % (D-3621) = 0.10 max) - AllChem |
| | Industries (Gainesville, FL) |
| Propylene | 1,2-Epoxypropane, Molecular Weight = 58.08 g/mol; Viscosity at 77° F. = |
| Oxide | 0.29 centipoise; Flash point Tag Closed Cup = −37.2° C.; Boiling point = |
| | 34.2° C.; Autoignition temperature = 465° C.) - ARC Specialty Products |
| | (New Hampton, NY) |
| VINNOL H | Carboxylate - containing terpolymer of approx. 84 wt. % vinyl chloride |
| 15/45 M | (VC), approx. 15 wt. % vinyl acetate (VAc) and approx. 1 wt. % |
| | dicarboxylic acid, Chlorine content (specific method) = 47.1-48.3 wt. %; |
| | K-value (DIN EN ISO 1628-2) = 47-49; Acid number/saponification |
| | number (specific method) = 5.5-7.5 mg KOH/g; Volatiles (specific |
| | method) = <1.0 wt. %; Viscosity (20% solids in MEK DIN 53015 20° C.) = |
| | 50-70 mPa*s; Density at 23° C. DIN 66137-2 1.36 g/cm³; Glass |
| | transition temperature DSC (DIN 53765/ISO 11357-5) = approx. 74° C.; |
| | Molecular weight (SEC, PS-Standard) = 60000-80000 MW) - Wacker |
| | Chemie AG (München, Germany) |
| UMCH | Terpolymer of approx. 84 wt % vinyl chloride (VC), approx. 14% wt % |
| | vinyl acetate (Vac) and approx. 2 wt % maleic acid, Molecular weight = |
| | 27000 MW; Glass transition temperature (Tg) = 74° C.; Inherent viscosity |
| | (ASTM-1243) = 0.5 DL/g; Specific Gravity (ASTM-792) = 1.35 g/cm3; |
| | Volatile Contents including moisture (GB/T 2914-1999) ≤1.0; Pile |
| | Density (GB/T 3402) ≥0.60) - Wuxi Honghui Chemical Co., Ltd (Wuxi |
| | City, China) |
| Ketonic Resin | Aldehyde Ketone resin, Hydroxy value = 170-200; Acid value = 0.2 max |
| KTR-100 | mg KOH/gm; Viscosity (50% in N-butyl acetate 25° C.) = 75-95 cps; |
| | Softening Range = 95-105° C.;) - Suparna Chemicals Limited (Mumbai, |
| | India) |
| Ketonic Resin | Aldehyde Ketone resin, Hydroxy value = 220-230; Acid value - 1.0 max |
| HK-100 | mg KOH/gm; Viscosity (50% ethanol Ford Cup) = 21 ± 1 sec at 30° C.; |
| | Softening Range = 92-102° C.; Bulk Density = 680-700 gm/ltr) - |
| | Aakash Chemicals (Glendale Heights, IL) |
| VERSAFLOW | 1-Decene, hydrogenated, homopolymer, Specific Gravity (ASTM D- |
| EV | 4052) = 0.840-0.846 g/ml; Weight/Gallon (ASTM D- 1475) = 7.01-7.03 |
| | lbs/gal; % Active Ingredients = 100%; Brookfield viscosity @ 77° F./ |
| | 25° C. (ASTM-445 = 740-1140 cps) - Shamrock Technologies, Inc. |
| | (Newark, NJ) |
| NEOCRYL B-890 | Modified MMA/BMA methacrylic copolymer, Average molecular |
| | weight (MW) = 12,500 Daltons, Viscosity, Brookfield 25° C. 30% in |
| | ethanol/water 94/6 = 25-50 mPa · s; Density 20° C. = 1.15 kg/l; Free |
| | monomer Max. = 3000 ppm; Tg (DSC) = 85° C.; Acid value (on solid) = |
| | 75 mg KOH/g; OH value (on solid) = 25 mg KOH/g) DSM Coating |
| | Resins (Netherlands) |
| NEOCRYL B-842 | BMA copolymer, Average molecular weight (MW) = 110,000; Viscosity |
| | Brookfield 25° C. 30% in MEK/ethylacetate 1/1 = 50-100 mPa · s; |
| | Density 20° C. = 1.08 kg/l; Free monomer Max. = 3000 ppm; Tg (DSC) = |
| | 47° C.; Softening point R&B = 155° C.; Acid value (on solid) = <1 mg |
| | KOG/g) DSM Coating Resins (Netherlands) |
| NEOCRYL B-725 | BMA/MMA copolymer, Average molecular weight (Mw) = 55,000, |
| | Viscosity Brookfield 25° C. 40% w/w in toluene = 300-450 mPa · s; |
| | Density 20° C. = 1.11 kg/l; Free monomer Max. = 3000 ppm; Tg(DCS) = |
| | 63° C.; Softening point R&B = 155° C.; Acid value (on solid) = 6.0 mg |
| | KOH/g) DSM Coating Resins (Netherlands) |
| NEOCRYL B-300 | Methacrylic copolymer; Viscosity: 0.8-1.0 (Pa · s at 25° C., 40% in |
| | HDDA); average Mw = 16,000 Dalton |
| NEOCRYL B-804 | BMA homopolymer; Highly thermoplastic resin; Acid value: 7 (mg |
| | KOH/g); Solid content: 100.0 (%); hydroxyl value: 25 mg KOH/g; Tg: 33° C.; |
| | average Mw = 160,000 Dalton |

### Testing

### Fineness of Pigment Dispersion or Grind

This method covers the measurement of fineness of dispersion or grind in Hegman units for pigment/vehicle systems. Techniques to measure the fineness of grind will be well known to a person skilled in the art and may be determined by standard methods such as ASTM D 1210-96. Pigment/vehicle ink mill-bases were drawn through a calibrated, tapered trough gauge. Pigment particles appeared at some point in the trough and particle size was measured. To produce certain film properties such as gloss, color and cleanliness, paint/ink mill-bases were processed to defined Hegman specification, then mill-based processing was continued. Equipment used was a standard Hegman unit, one or two path, grind gauge and a scraper blade and a suitable vehicle for mill-base reduction.

The following procedure was used:
A. Obtain a representative mill-base sample. Reduce the mill-base to approximate finished product pigment/vehicle ratio with suitable resin vehicle. Mix thoroughly.
B. Place enough test material into the deep end of the gauge path to reach the end of the path during testing.
C. Using scraper held with both hands, resting firmly on gauge at slight angle to vertical, draw the specimen briskly toward the shallow end of the gauge.
D. Immediately view the specimen in the path for a point at which a concentration of pigment particles (speckles) appear. This point is the fineness reading and was made within 10 seconds after drawing the sample down on the gauge. Report fineness of grind as units Hegman to the nearest 2 units.

### Viscosity by Zahn cup

This test method covered the measurement of the viscosity of paints/inks by the Zahn dip type viscosity cup. Paint/ink was drained from a cup of known volume through a standard orifice. Efflux time was measured and reported as coating viscosity. Techniques to measure the viscosity by Zahn cup are well known to a person skilled in the art and may be determined by standard methods such as ASTM D 4212-93.

The following equipment was used: Zahn cups (#1, 2, 3 & 4), thermometer (calibrated), and a timing device capable of 0.2 second accuracy.

The following procedure was used:
A. Obtain a representative batch sample.
B. Condition the Zahn cup and sample to 77° F.
C. Dip the Zahn cup into the sample so the cup is completely inserted.
D. Lift the Zahn cup from the sample and start timer simultaneously.
E. Stop timing at the first definite break in efflux stream. The elapsed time is the sample viscosity measured in seconds. Report viscosity as seconds, number X Zahn cup at 77° F.

### Weight Per Gallon by Cup

Known volume and WPG was calculated. WPG by cup is a reproducible method for determining WPG. Techniques to measure the weight per gallon by cup will be well known to a person skilled in the art and may be determined by standard methods such as ASTM D 1475-96.

The equipment used included: Gardner US standard weight per gallon cup, Thermometer, Mass Balance capable of 0.1 gram accuracy; tared to empty cup weight.

The following procedure was used:
A. Obtain representative batch sample.
B. Condition sample and cup to 77° F.
C. Fill cup to almost overflowing. Place lid on cup and press on firmly to release trapped air. Wipe off excess paint.
D. Weight cup. Calculate WPG as follows: WPG=Sample weight in grams×0.1
E. Report WPG as lbs/gal at 77° F. calculated to 0.01 lbs.

### Adhesion by 610 Tape

This method covered the evaluation and measurement of the ink/coating to substrate adhesion by the 610 tape method. Adhesion of a cured ink/coating film was applied to the appropriate film substrate and tested by applying a tape available from 3M, St. Paul, Minn., under the trade designation 610 Transparent Cellophane Tape, to the sample. The tape was then removed sharply and evaluated for coating to substrate adhesion. The 610 tape adhesion test was a reproducible way to quantify the ink/coating to substrate adhesion.

The equipment used included: Cured films prepared to coating test specifications, 3M 610 tape 1 in. (2.5 cm)×72 Yd. (66 m) roll.

The following procedure was used:
A. Apply tape over the cured film and smooth tape down with firm thumb pressure, eliminating all air bubbles and wrinkles to insure good tape-to-coating contact.
B. Remove tape by pulling a free end smartly (but not jerking) back upon itself as close to a 150 degree angle as possible.
C. Observe tested area and adhesive side of tape for coating-to-substrate delamination.
D. Rate tape adhesion results as a function of coating removed from the substrate on a scale of 0-10 with 0 being no coating removed from the test area, 10, indicates complete removal. A rating of 2 or less, or 1 or less, indicated a pass of the adhesion test.

### Weight % Volatile/Non-Volatile

This method covered the measurement of the percent by weight of volatile/non-volatile matter in coatings including both solvent-based and water-reducible. Percent volatile/non-volatile of a paint was determined by baking a sample of known weight in a 115° C.±5° C. oven for 15 minutes and calculating % weight volatile/non-volatile content by weight loss. Techniques to measure the weight % volatile/non-volatile are well known to a person skilled in the art and may be determined by standard methods such as ASTM D 2369-97.

The equipment used included: Aluminum foil dish—Fisher 08-732 preconditioned at 110° C. for 30 minutes in a desiccator, Forced air oven—Blue M #2 (E145 type), Syringe—Disposable—BD 9586, n-propyl acetate as a suitable solvent, analytical balance capable of 0.0001 gram accuracy.

The procedure was as follows:
A. Obtain representative batch sample
B. Weigh, by difference from syringe, 1 gram±0.1 gram, sample into preconditioned, tared, foil dish. Run at least 2 specimens for each trial.
C. Add 3 ml±1 ml of n-propyl acetate and disperse sample evenly.
D. Bake samples 115° C. degrees for 15 minutes and place in desiccator for 5 minutes to cool and reweigh.
E. Calculate volatile % as follows:

V%=100−[((W2−W1)/S)×100]
where: V %=% Volatile
   W1=Weight of dish
   W2=Weight of dish and specimen, dry (after baking)
   S=Weight of specimen (before baking)
F. Calculate non-volatile % as follows:

N%=100−V%
G. Report N % as % solids of coating to 00.01% as the mean of N % for both specimens.

### Differential Scanning Calorimetry for Tg

Samples of material for differential scanning calorimetry (“DSC”) testing were weighed into standard sample pans, and analyzed using the standard DSC heat-cool-heat method. The samples were equilibrated at −60° C., then heated at 20° C. per minute to 200° C., cooled to −60° C., and then heated again at 20° C. per minute to 200° C. The glass transition temperatures were calculated from the thermogram of the last heat cycle. The glass transition was measured at the inflection point of the transition.

### Color Match Control

This method covered the determination of color match acceptability. The color of a cast and cured film was evaluated colorimetrically for conformance to a color standard and batch history. Standardized color matching techniques were required to reduce batch to batch color variations.

The method was conducted with an X-Rite 968 Spectrophotometer System, available from X-Rite Pantone, Inc., Grand Rapids, Mich.

The procedure was as follows:
A. Prepare a “Base Color” panel according to the defined specification for product being tested.
B. Measure the “Base Color” panel according to the X-Rite Spectrophotometer manufacturer's instructions.
C. Report PASS/FAIL as follows:
   Delta E value 1 or less=PASS
      Delta E>1=FAIL

### Ink Bleed Testing Procedure

This test method covered the measurement of the change in color of a caustic wash solution that results from the Association of Postconsumer Plastic Recycling protocol for producing PET flake for evaluation and evaluating for discoloration from bleeding labels.

Representative shrink sleeve labels were cut into ¼ inch (0.6 cm) squares and blended with PET bottle material cut into ½ inch (1.3 cm) squares and added under agitation into a 185-195° F. (85° C.-91° C.) wash solution. The solution, inked label pieces and PET bottle pieces are stirred for 15 minutes at temperature. The label pieces and bottle pieces are filtered from the wash solution and the solution is observed for discoloration.

The equipment used included: Inked shrink sleeve labels prepared to test specifications using the ink of Example A below, PET Bottle material, NaOH wash solution, hot plate capable of heating to 90° C., 1000 ml beaker, scale or balance capable of measuring 500 (±0.5 grams), overhead stirrer capable of 600 rpm, stirring impeller (pitched and 1.75 inch (4.45 cm) diameter), thermometer and a strainer (non-aluminum fine mesh).

A wash solution was prepared including 1600 g Deionized Water, 4.8 g Triton X-100, and 10 g Sodium Hydroxide Pellets. The deionized water was heated to 100° F. and Triton X-100 was added under agitation. The solution was mixed for 5 minutes or until dissolved. Sodium hydroxide pellets were added under agitation and mixed for 10 minutes or until dissolved.

Inked sleeve labels were prepared using a K-Proofer Instrument with a 150 Line plate and a 120 Stylus. The ink sleeve labels were printed on a clear PETG film according to the K-proofer manufacturer's instructions. Two bumps of SB/INK-10388 white ink were applied to the label, and the label was dried for 15 seconds in a 50° C. (122° F.) Static Oven.

400 mL of the above wash solution was charged into a 1000 mL beaker and heated on a hot plate under agitation (with a 1.75 inch (4.45 cm) diameter paddle blade) to 185° F. (85° C.). 200 g of PET bottle material (cut into ½ inch (1.3 cm) squares) was added into the heated solution under agitation with the stirrer set to 540 revolutions/minute.

6 g of inked shrink sleeve labels (cut into ¼ inch (0.64 cm) squares) were added into the heated solution under agitation with the stirrer set to 540 revolutions/minute.

The solution, PET bottle material and shrink sleeve labels were mixed while maintaining a temperature of 185° F.-190° F. (85°-88° C.) for 15 minutes.

After 15 minutes, the beaker was removed from the hot plate and separate the PET bottle material and inked shrink sleeve labels from the wash solution with a strainer.

The wash solution was then measured for discoloration (bleeding) from the ink into the caustic wash at the following wavelengths (nm): 375, 425, 475, 525, 575, 625, 675 and 725 using a photospectrometer available from Thermo Fisher Scientific, Waltham, Mass., under the trade designation Spectronic 200. The absorption readings were taken for each wavelength, and then added together and evaluated as follows:
<0.75=PASS (minimal ink bleed, solution is clear); and
>0.75=FAIL (moderate ink bleeding, solution is moderately discolored from the inks)

The inked shrink sleeve labels were observed to determine the amount of ink removal, and rated to estimate the % of ink removed from the label, with 100%=complete ink removal and 0%=No ink removal.

### Ink Composition Example A

The ink composition was prepared by the following procedure.

First, an intermediate was prepared as shown in Table 1 below:

TABLE 1

| | | weight | |
|---|---|---|---|
| Steps | Raw materials | parts | Preparation instructions |
| 1 | | | In blending tank |
| 2 | n-Propyl Acetate | 74.9001 | |
| 3 | | | Add next item under agitation |
| 4 | UMCH | 25.008 | |
| 5 | | | High speed mix until dissolved |
| 6 | | | Add next item under agitation |
| 7 | Propylene Oxide | 0.0991 | |
| 8 | | | Blend for 10 minutes |

The solvent-based ink composition was prepared as shown in Table 2 below:

TABLE 2

| | | weight | |
|---|---|---|---|
| Steps | Raw materials | parts | Preparation instructions |
| 1 | | | In blending tank |
| 2 | Intermediate | 14.9279 | |
| | (resulting from | | |
| | above) | | |
| 3 | | | Add next items under agitation |
| 4 | Solsperse 20000 | 1.1219 | |
| 5 | n-Propyl Acetate | 26.2487 | |
| 6 | Special Black #4 | 11.196 | |
| | Powder | | |
| 7 | | | High speed disperse for 15 minutes |
| 8 | | | Mill to minimum of 8 on Hegman |
| | | | gauge |
| 9 | | | |
| 10 | | | Add next 3 items under agitation |
| 11 | Intermediate | 11.9442 | |
| 12 | Ketonic Resin | 4.4765 | |
| | HK100 | | |
| 13 | S-395 N1 Wax | 0.25 | |
| 14 | | | High speed mix for 30 minutes |
| 15 | | | Preblend next 3 items and add to |
| | | | batch under agitation |
| 16 | n-Propyl Acetate | 1.0848 | |
| 17 | n-Butyl Acetate | 12.5 | |
| 18 | Isopropanol 99% | 15 | |
| 19 | | | Mix for 10 minutes |
| 20 | | | Add next item under agitation |
| 21 | Versaflow EV | 1.25 | |
| 22 | | | Mix for 30 minutes |

The properties of the above-described ink composition are shown in Tables 3-4 below. In Table 3, L* refers to the lightness value in the CIELAB color space, wherein L*=0 is black and L*=100 is bright white. The color channels a* and b* represent true neutral grey values at a*=0 and b*=0. The a* axis represents the green-red component, with green in the negative direction and red in the positive direction. Haze is defined as the lack of transparency in the material, and can be evaluated, for example, under ASTM D1003-13.

The control used in this example was a clear PETG available from SKC, Covington, Ga. Comparative Examples A and B were commercially printed labels using a non-washable ink.

TABLE 3

| Property | Result |
|---|---|
| Viscosity by Zahn Cup | 25 +/− 5 seconds in #2 Cup |
| Weight Per Gallon by Cup | 8.00 +/− 0.2 |
| Weight % Volatile/Non-volatile | 24.5 +/− 0.5% |
| Color Match Control | Pass |
| Adhesion by 610 Tape | Pass |
| Ink Bleed Test Rating | 0 |
| Ink Removal | 100% |
| Particle Size (Mean) | 163 μm |
| Particle Size (Main Distribution) | 90 μm |

TABLE 4

| Sample | L* | a* | b* | Haze |
|---|---|---|---|---|
| Control | 93.77 | −0.53 | 2.38 | 2.35 |
| Example A | 93.55 | −0.47 | 2.69 | 3.06 |
| Comparative A | 92.79 | −0.57 | 3.14 | 4.05 |
| Comparative B | 91.49 | −0.63 | 3.05 | 4.41 |
| Specification | >82 | Δ < 1.5 | Δ < 1.5 | <20 |

This ink was tested according to the Ink Bleed Testing Method described above and rated for Ink Bleed and Ink removal from the inked shrink sleeve label. The NaOH wash solution resulting from the Ink Bleed Testing Method was then measured for particle size distribution.

Particle size distributions for an example ink layer material were determined. In one example, multi-modal particle size distribution with left shoulder centered near 7 microns (μm), main distribution near 80 μm and right shoulder near 700 μm; 90% of the particles were 267 μm smaller with a mean size of 137 Mean sizes were typically less than 200 μm.

### Ink Composition Example B

The ink composition was prepared by the following procedure:

First, an intermediate was prepared as summarized in Table 5 below:

TABLE 5

| | | weight | |
|---|---|---|---|
| Steps | Raw materials | parts | Preparation instructions |
| 1 | | | In blending tank |
| 2 | n-Propyl Acetate | 60.000 | |
| 3 | Isopropanol 99% | 15.00 | Add next item under agitation |
| 4 | NEOCRYL B-842 | 25.000 | |
| 5 | | | Blend for 10 minutes |

The solvent-based ink composition was prepared as shown in the following Table 6:

TABLE 6

| | | weight | |
|---|---|---|---|
| Steps | Raw materials | parts | Preparation instructions |
| 1 | | | In blending tank |
| 2 | Intermediate | 37.8200 | |
| | (resulting from | | |
| | above) | | |
| 3 | | | Add next items under agitation |
| 4 | Solsperse 20000 | 0.7700 | |
| 5 | Pthalo Blue | 7.7100 | |
| | Pigment | | |
| 6 | | | High speed disperse for 15 minutes |
| 7 | | | Mill to minimum of 8 on Hegman |
| | | | gauge |
| 8 | | | Preblend next 3 items and add to |
| | | | batch under agitation |
| 9 | Intermediate | 10.5000 | |
| 10 | Ketonic Resin | 3.9500 | |
| | HK100 | | |
| 11 | S-395 N1 Wax | 0.2200 | |
| 12 | | | High speed mix for 30 minutes |
| 13 | | | Preblend next 3 items and add to |
| | | | batch under agitation |
| 14 | n-Propyl Acetate | 18.4000 | |
| 15 | n-Butyl Acetate | 5.0000 | |
| 16 | Isopropanol 99% | 15.630 | |
| 17 | | | Mix for 10 minutes |

The properties of the above-described Ink Composition B are shown in Table 7 below.

TABLE 7

| Property | Result |
|---|---|
| Viscosity by Zahn Cup | 25 +/− 5 seconds in #2 Cup |
| Weight Per Gallon by Cup | 8.00 +/− 0.2 |
| Weight % Volatile/Non-volatile | 24.5 +/− 0.5% |
| Color Match Control | Pass |
| Adhesion by 610 Tape | Pass |

### Ink Bleed Test Results

The NEOCRYL B-842 acrylic resin in the Ink Composition B was replaced with NEOCRYL B-300 acrylic resin to form Ink Composition C, was replaced with NEOCRYL B-725 acrylic resin to form Ink Composition D, and was replaced with NEOCRYL B-804 acrylic resin to form Ink Composition E.

Ink Compositions B-E were then measured for ink bleed according to the Ink Bleed Test Procedure described above. The results are shown in Table 8 below:

TABLE 8

| Ink | | Acrylic | Acrylic | | |
|---|---|---|---|---|---|
| Composition | Acrylic | Resin Tg | Resin Acid | Acrylic | |
| Sample | Resin | (° C.) | # (mg KOH/g) | Resin M_{w} | Absorbance |
| B | NEOCRYL | 47 | <1 | 110,000 | 0.454 |
| | B-842 | | | | |
| C | NEOCRYL | 45 | <1 | 16,000 | 4.851 |
| | B-300 | | | | |
| D | NEOCRYL | 63 | 6 | 55,000 | 0.428 |
| | B-725 | | | | |
| E | NEOCRYL | 33 | 7 | 160,000 | 3.980 |
| | B-804 | | | | |

The lower absorbance values for Ink Compositions B and D in Table 8 above indicated that ink layers formed from these ink compositions had less ink bleed into the wash solution than ink layers formed from Ink Compositions C and E. When processed in the wash solution, the polymeric labels and bottles having ink layers formed from Ink Compositions B and D left the wash solution with better clarity compared to the wash solution used to process ink layers formed from Ink Compositions C and E.

The results shown in Table 8 also indicate that acrylic resins with a Tg of about 45° C. to about 65° C. and a Mw of about 55,000 to about 110,000 had the lease ink bleed into the wash solution.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the embodiments set forth herein as follows.

1. An ink composition, comprising:
a polymeric binder comprising an addition copolymer and a ketone aldehyde resin, wherein the addition copolymer is chosen from acrylic resins, vinyl resins comprising copolymers of vinyl chloride and vinyl acetate, and mixtures and combinations thereof; and
a liquid carrier comprising at least one organic solvent.

2. The ink composition of claim 1, wherein the ketone aldehyde resin has a softening point of about 75° C. to about 120° C.

3. The ink composition of claim 1, wherein the ketone aldehyde resin comprises an aldehyde-cyclohexanone copolymer.

4. The ink composition of claim 1, wherein the vinyl resin has a glass transition temperature (Tg) of about 25° C. to about 90° C. and a molecular weight M_{w} of about 20,000 to about 150,000.

5. The ink composition of claim 1, wherein the vinyl resin comprises a terpolymer comprising vinyl chloride, vinyl acetate and an acid group.

6. The ink composition of claim 5, wherein the acid group is chosen from carboxylic acids, maleic acid, and mixtures and combinations thereof.

7. The ink composition of claim 1, wherein the acrylic resin has a molecular weight M_{w} of about 20,000 to about 120,000 and a glass transition temperature Tg of about 40° C. to about 90° C.

8. (canceled)

9. The ink composition of claim 1, wherein the acrylic resin comprises a copolymer of (meth)acrylic acid.

10. The ink composition of claim 1, wherein the acrylic resin is a copolymer of alkyl methacrylates.

11. The ink composition of any one of claim 1, wherein the liquid carrier comprises from about 20 wt % to about 80 wt % of an alcohol, relative to the total weight of the liquid carrier.

12. (canceled)

13. The ink composition of claim 11, wherein the liquid carrier comprises an acetate, and wherein the acetate is present in an amount of up to about 80%, relative to the total weight of the liquid carrier.

14. (canceled)

15. The ink composition of claim 1, wherein the ratio of the addition copolymer to the ketonic resin in the polymeric binder component of the ink composition is from about 10 to about 60.

16-22. (canceled)

23. The ink composition of claim 1, wherein the ink composition comprises about 5 wt % to about 50 wt % of the binder and about 50 wt % to about 95 wt % of the liquid carrier.

24. The ink composition of claim 23, further comprising 0 wt % to about 25 wt % of a pigment.

25. (canceled)

26. A label, comprising:
an ink layer disposed on a polymeric film, wherein at least about 80 weight % of the ink layer comprises at least one pigment and a polymeric binder, the polymeric binder comprising an addition copolymer and a ketone aldehyde resin, wherein the addition copolymer is chosen from acrylic resins, vinyl resins comprising copolymers of vinyl chloride and vinyl acetate, and mixtures and combinations thereof.

27. The label of claim 26, wherein the ink layer comprises up to 15 layers.

28. The label of claim 26, wherein at least about 80 weight % of the ink layer separates from the polymeric film when the label is agitated in an aqueous alkaline solution at a temperature of at least about 150° F.

29-32. (canceled)

33. The label of claim 26, wherein the polymeric film comprises at least one of heat shrinkable PET, PETG or PETC.

34-39. (canceled)

40. The label of claim 26, wherein the label is on a single serve PET beverage container.

41-46. (canceled)

47. A method for recycling a polymeric food or beverage container, wherein the container has an ink layer on a surface of the container or on a label affixed to the container, the method comprising:
pulverizing a plurality of the container and any labels thereon to form a mixture of flakes, wherein at least a portion of the flakes comprise the ink layer; the ink layer comprising at least one pigment and a polymeric binder, the polymeric binder comprising an addition copolymer and a ketone aldehyde resin, wherein the addition copolymer is chosen from acrylic resins, vinyl resins comprising copolymers of vinyl chloride and vinyl acetate, and mixtures and combinations thereof;
placing the flakes in an aqueous alkaline wash bath, wherein the wash bath has a temperature of about 75° C. to about 85° C.;
separating at least about 95 wt % of the ink layer from the portion of the flakes having the ink layer such that the ink layer forms ink particulates that are insoluble in the water bath, and wherein both the wash bath and the flakes therein are substantially untinted;
removing the untinted flakes from the wash bath; and
recycling the untinted flakes to form recycled food or beverage containers.

48-49. (canceled)

50. The method of claim 47, wherein the food or beverage container is substantially clear PET, PETG or PETC.

51-55. (canceled)
